(19) United States
(12) Patent Application Publication
(10) Pub. No.: US 2016/0079909 A1
(43) Pub. Date: Mar. 17, 2016

(54) PHOTOVOLTAIC PANEL MOUNTING SYSTEM

(71) Applicants: Scott Franklin, Nederland, CO (US); Christopher Klinga, Boulder, CO (US); Brian Rafferty, Longmont, CO (US)

(72) Inventors: Scott Franklin, Nederland, CO (US); Christopher Klinga, Boulder, CO (US); Brian Rafferty, Longmont, CO (US)

(73) Assignee: LUMOS LSX, LLC, Boulder, CO (US)

(21) Appl. No.: 14/488,881

(22) Filed: Sep. 17, 2014

(51) Int. Cl. H02S 20/22; F16M 13/02; F16B 2/20; H02S 20/23

(52) U.S. Cl. CPC H02S 20/22; H02S 20/23; F16M 13/02; F16B 2/20

(57) ABSTRACT

A photovoltaic panel mounting system having a pair of spaced mounting rails, one or more fastener retaining devices and a plurality of quick access fasteners. Each of the pair of spaced mounting rails has a first end, a second end and a plurality of mounting holes. The one or more fastener retaining devices are aligned with the plurality of mounting holes in each of the rails and each of the quick access fasteners is removably secured to one of the rails through one of the plurality of mounting holes. The quick access fasteners are securable and removable to one of the one or more fastener retaining devices with less than one revolution of the quick access fastener. The plurality of the quick access fasteners can be quarter turn fasteners.

This application claims priority from provisional application Ser. No. 61/878,995, filed on Sep. 17, 2013, which is incorporated herein in its entirety.

### FIELD OF INVENTION

The present invention relates to a system for mounting photovoltaic panels. In particular, the present invention relates to a system that provides for fast attachment and removal of photovoltaic panels from a support structure.

### BACKGROUND OF THE INVENTION

Photovoltaic (“PV”) modules, also known as solar panel modules, are typically mounted to support structures and include a photovoltaic panel and the associated electrical wiring for connecting the module to a desired circuit. PV modules are typically installed on the roofs of buildings or homes in order to place them in the best position for receiving the direct and uninterrupted sunlight that is necessary to generate electricity. However, mounting the modules on such structures can be difficult since they need to be properly aligned in order to work most efficiently and also to be more aesthetically pleasing.

PV modules are mounted on a support structure that typically consists of a plurality of spaced elongate rails. The rails are designed to accommodate one or more PV panels along their length. Such rails must be properly aligned and spaced from each other in order to provide a mounting surface and attachment points that correspond to the mounting apertures in the PV module. If one rail is not parallel to the other and spaced appropriately from the other to provide the correct amount of support for the module installation, the attachment points will not align with the mounting apertures in the PV panels. Also, rails may have to be adjusted in length to accommodate a particular installation. Therefore, a significant amount of time and effort must be expended on top of a roof to install and align the rails.

The installation of the PV panel systems on the roofs of structures can be a time consuming operation and a significant part of the cost for an owner. First, the support structure has to be attached to the roof and then each panel must be secured to the support structure using a plurality of fastening devices. Therefore, anything that reduces the installation time reduces the overall cost of the PV panel system. Since a large number of fastening devices are used to secure the PV panels to the support structure, reducing the time needed for installing the fastening devices would reduce the overall time required for installing the PV panel system.

Accordingly, there is a need for a fastening system that uses fastening devices that can be installed easily and in less time than the fastening devices currently being used.

### SUMMARY OF THE INVENTION

In accordance with the present invention, a photovoltaic panel mounting system is provided. The photovoltaic panel mounting system comprises, consists of or consists essentially of a pair of spaced mounting rails, one or more fastener retaining devices and a plurality of quick access fasteners. Each of the pair of spaced mounting rails includes a first end, a second end and a plurality of mounting holes. The one or more fastener retaining devices are aligned with the plurality of mounting holes in each of the rails. Each of the quick access fasteners is removably secured to one of the rails through one of the plurality of mounting holes. The quick access fasteners are securable and removable to one of the one or more fastener retaining devices with less than one revolution of the quick access fastener. The plurality of the quick access fasteners can be quarter turn fasteners and they can have a head with a shaft extending therefrom to a distal end.

In a preferred embodiment, the one or more fastener retaining devices includes a rod extending along the length of the rail or a pin in the rail located at each of the plurality of mounting holes. The quarter turn fastener has an engaged position and a disengaged position. When in the engaged position, the fastener, preferably a notch at the distal end, engages the rod and the fastener is secured to the mounting rail. When in the disengaged position, the fastener does not engage the rod and the fastener is not secured to the mounting rail.

Each of the spaced mounting rails is elongated and has a base, first and second side walls extending upwardly therefrom and one or more top plates; preferably first and second top plates. The side walls can be substantially parallel or they can extend from the bottom wall to the top plate at an angle to provide additional structural strength. In a preferred embodiment, the side walls and the bottom wall and top plate have a trapezoidal shape, when viewed form one of the ends of the rail. The first and second top plates extend inwardly from the side walls and parallel to the base to define an interior. Preferably, the plurality of mounting holes is formed in the first top plate. In addition, each of the pair of spaced mounting rails can include a passage having a first end and a second end corresponding to the first and second ends of the rails. The passage is located in the interior and is in communication with the plurality of mounting holes. In preferred embodiments, the one or more fastener retaining devices are positioned in the passage; most preferably, the rod is positioned in the passage. The rod can also be attached to the rail by a plurality of clips that attach to a lip on the top wall of the rail.

In another embodiment, each of the pair of spaced mounting rails has a first end, a second end, a bottom wall, a top plate and one or more side walls therebetween. The bottom wall, top plate and one or more side walls define an interior and an exterior and the top plate has a plurality of mounting holes. The one or more fastener retaining devices, preferably a rod extending the length of the passage, are located in the interior and align with the plurality of mounting holes in each of the rails. The passage is in communication with the exterior through the plurality of mounting holes. Preferably, the passage is formed by two curved walls extending from the top plate into the interior.

### BRIEF DESCRIPTION OF THE DRAWINGS

The preferred embodiments of the photovoltaic panel system of the present invention, as well as other objects, features and advantages of this invention, will be apparent from the accompanying drawings wherein:

FIG. 1 is a perspective view of the photovoltaic mounting system shown secured to a roof of a structure.

FIG. 2 is a detail view of the mounting system of FIG. 1.

FIG. 3 is a side elevational view showing a PV panel mounted to a rail.

FIG. 4 is a top perspective view showing a mounting rail and a fastener retaining rod prior to insertion in the passage.

FIG. 5 is a partial top view of a rail PV panel mounting hole.

FIG. 6 is a side view of a rail showing fasteners.

FIG. 7 is a top perspective view of a solar panel being secured to a mounting rail.

FIG. 8 is an exploded side elevational view.

FIG. 9 is a side elevational view showing a mounting rail with a fastener therein;

FIGS. 10 and 11 are side elevational views showing different embodiments of fastener receptacles.

FIG. 12 is an end perspective view of an embodiment of the mounting rail that uses a nut captured in a track in the rail.

FIG. 13 is a top view of the mounting rail in FIG. 12 after the captured nut is moved to an intermediate position in the track.

FIG. 14 is a perspective view of an alternative embodiment of the rail.

FIG. 15 is a perspective view of a clip.

FIG. 16 is an end view of the rail of FIG. 14 with a panel secured thereto.

FIG. 17 is a perspective view of the rail with an alternative embodiment of the clip.

FIG. 18 is a bottom perspective of the clip of FIG. 17.

FIG. 19 is cross-sectional view of the rail of FIG. 17 with a photovoltaic panel attached.

FIG. 20 is a perspective view of a further alternative embodiment of the clip.

FIG. 21 is a top plan view of the clip of FIG. 20.

FIG. 22 is a side elevational view of the clip of FIG. 20.

### DETAILED DESCRIPTION OF THE PREFERRED EMBODIMENTS

The present invention provides a mounting system for photovoltaic (“PV”) panels. The PV panels may be frameless solar panels having mounting apertures (i.e., through holes) formed therein in order to receive quick access fasteners, also referred to as quick release fasteners. The use of traditional threaded fasteners in a solar mounting system, which require five or more 360-degree revolutions to secure, takes time and can be cumbersome. Unlike traditional screw fasteners that require multiple revolutions for them to be secured, the use of the quick access fasteners reduces the time it takes to install the solar panels. Quick access fasteners may be secured and removed to a structure with less than one revolution. One type of quick release fastener is known in the art as a quarter turn fastener since it can be moved between a secured and unsecured position with only a quarter revolution (i.e., 90 degrees) of the fastener. The use of quick access fasteners allows the PV panels to be quickly and securely fastened to the rails of the support structure and removed therefrom.

In a typical installation of the photovoltaic panel mounting system of the present invention, the pair of rails is positioned on a structure, such as a roof, and spaced apart so that the mounting holes in the top plates of the rails correspond with the mounting apertures in the photovoltaic panel. The rails are then secured to the structure and, in a preferred embodiment, a rod is inserted into the passage located on the interior side of the top plate. The passage is in communication with the plurality of holes in the top plate. The solar panel is then positioned on the pair of rails so that the mounting apertures in the photovoltaic panel are aligned with the holes in the top plate. Optionally, one or more insulators can be positioned between the top plate of the rail and the photovoltaic panel. The quick access fasteners are then inserted in the mounting apertures of the photovoltaic panel, pass through the optional insulator and holes in the top plate of the rail. The quick access fasteners are then rotated in the clockwise direction, preferably one-half turn, more preferably one-quarter turn to engage the rod in the passage and secure the photovoltaic panel to the mounting system. The photovoltaic panel can be quickly and easily removed from the mounting system by rotating the quick access fasteners in a counter-clockwise direction or by removing the rod from the passages in the pair of mounting rails.

As used herein, the term “quarter turn fastener” refers to a fastening device that is fully tightened by rotating the device one-quarter of a revolution or 90-degrees. The fastening device has a head with a shaft extending therefrom to a distal end. The head is used to turn or rotate the shaft and the distal end has various designs that can engage a structure by rotating the shaft one-quarter turn. For example, the shaft can have a notch that receives the retaining device and is secured by rotating the fastener. Quick access securement fasteners known in the art include Dzus® quarter turn fasteners or other similar type fasteners. Such quick access fasteners are also marketed by DFCI Solutions, Inc. under their quarter turn-ST-1200 line.

By using the quick attach and release fasteners, an installer of the PV panels can quickly attach the panel to the rail. Often these PV panels are placed on roofs or overhead structures where installment can be difficult. Therefore, the ability to quickly attach the panels significantly eases the installation process. In addition, if a panel needs to be replaced the fasteners need only be rotated a portion of a revolution to release the panel from the rail allowing a new panel to be installed.

In the mounting system of the present invention, no torque specifications are necessary with the use of the quick access fasteners. The fastener is either off and loose or on and tight. This reduces the amount of tools needed to install the solar system. In particular, the use of a quarter turn fastener is beneficial since the use of mounting hardware extending directly through a PV panel can break the solar panel due to over tightening. The use of the quick access quarter turn fastener reduces this risk.

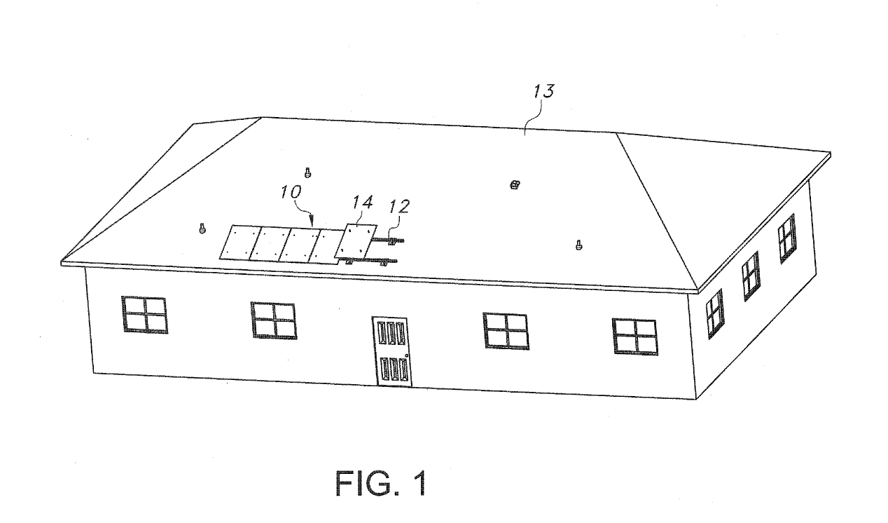

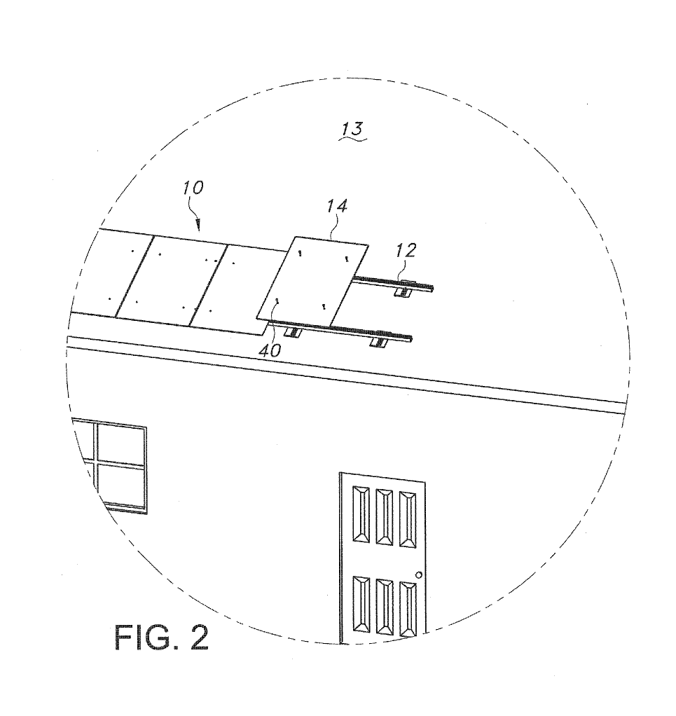

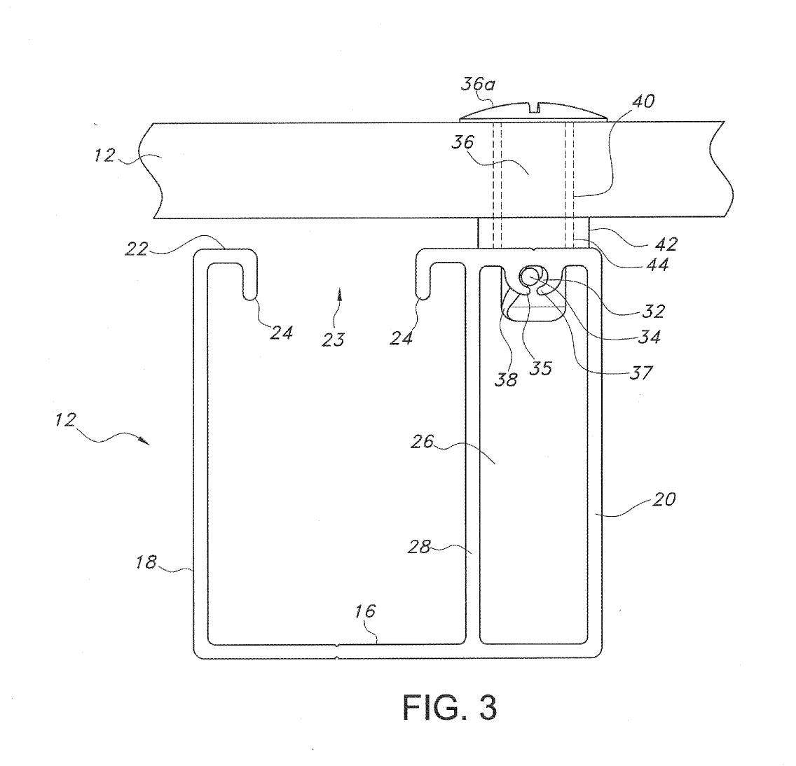

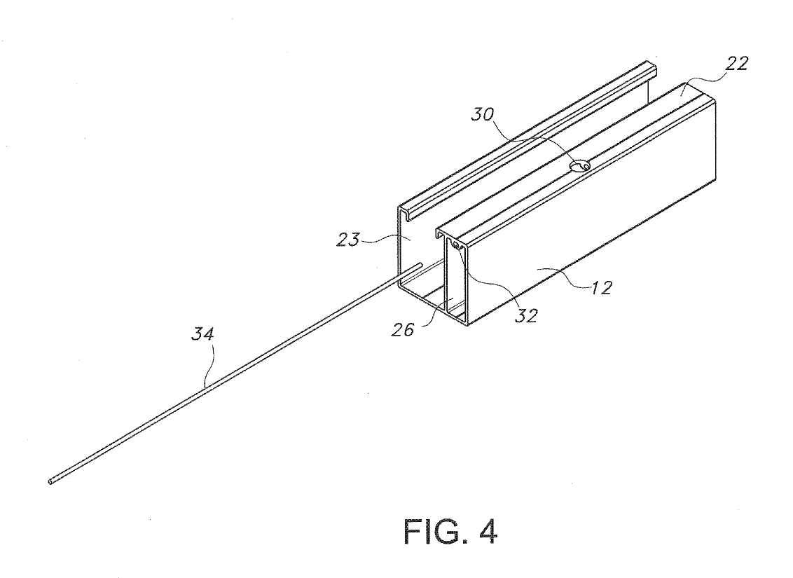

With reference to FIGS. 1 and 2, the mounting system 10 includes a pair of spaced PV panel mounting rails 12 that are secured to a support structure 13 such as the roof of a house or building. PV panels 14 are secured to the rails 12. With reference to FIGS. 3-4, the mounting rail 12 may include a bottom wall 16 and two upwardly standing side walls 18, 20 connected to a top wall 22. The bottom wall 16 can have holes for screwing or bolting the rail 12 to a structure. The top wall 22 includes an opening into a first channel 23 formed along the longitudinal length thereof. The top wall 22 includes two downwardly depending ends 24 which define the width of the channel opening. Located adjacent to the first channel 23 is a second channel 26 which is enclosed. The first and second channels 23, 26 are separated by a dividing wall 28. The rails 12 may be formed of a rigid material such as extruded aluminum or a hard plastic.

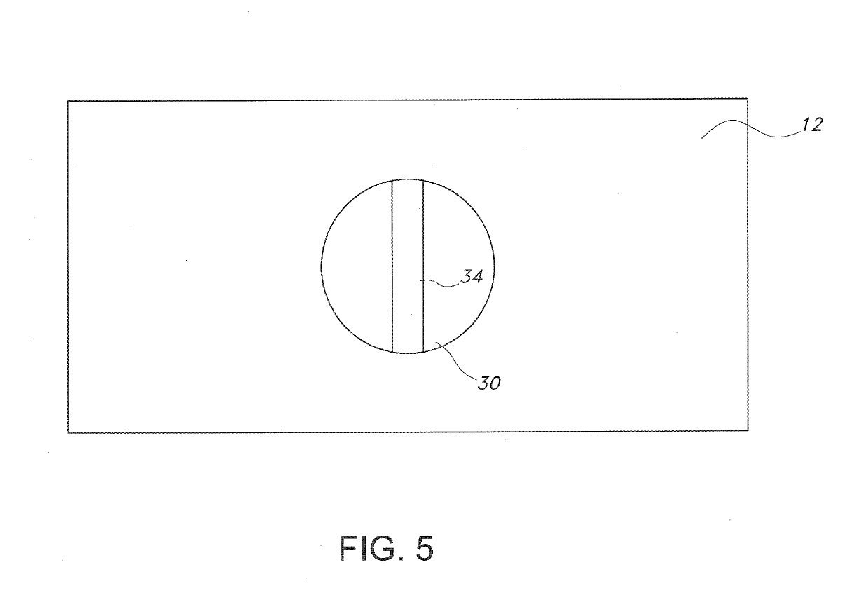

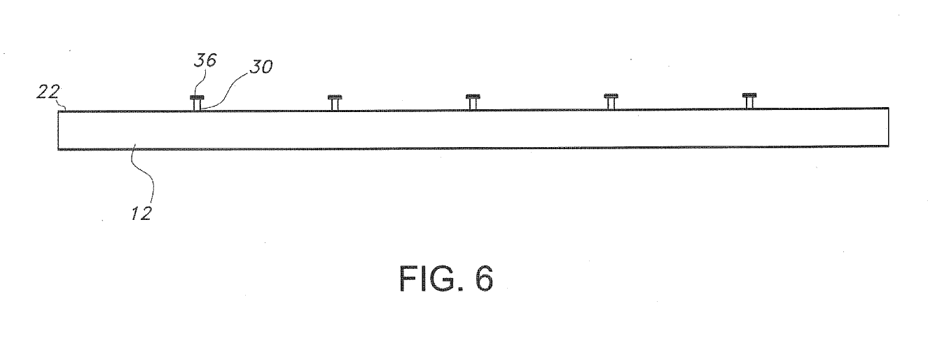

With reference to FIGS. 4 and 6, the top wall 22 includes a plurality of mounting holes 30 formed therein which communicate with the second channel 26. The holes 30 each include a fastener retaining device for securing a quick access fastener 36. The upper portion of the second channel includes a passage 32 extending along the length of the rail 12. A fastener retaining rod 34 is inserted in the passage 32 and extends along the length of the rail 12. The rod 34 may be formed of a resilient material such as spring steel. With the rod 34 inserted in the rail 12, the rod 34 extends past the mounting holes 30 formed in the rail 12 as shown in FIG. 5. The rod 34 is spaced a distance from the top surface of the rail 12. The rod 34 forms an attachment point for a quick access fastener 36. The use of the elongate rod 34 eliminates the need to have individual retaining devices such as fastener receptacles for each mounting hole 30, and eases the assembly of the solar mounting system 10. Only one part is needed to mate with multiple fasteners instead of one part per fastener.

As shown in FIG. 3, the fastener 36 may be a quarter turn fastener of a type known in the art. One end of the fastener may include a ramped passage 38 formed therein which engages the rod 34. While the drawings presented herein show a fastener including a passage formed by two inwardly curving side walls 35, 37, it is within the contemplation of the present invention that other quick access fasteners may be used. Preferably, the two inwardly curving side walls 35, 37 are integrally formed as part of the rail 12, most preferably the rail 12 and side walls 35, 37 are formed by an extrusion process.

In order to secure the fastener 36 within the mounting holes 30, the end of the fastener 36 is inserted into the hole 30 so that the fastener passage engages the rod 34. The fastener 36 is then turned, which causes the fastener to be pulled toward the rail 12 to a secured position. To remove the fastener 36, the fastener 36 is turned in the opposite direction (i.e., counter clockwise) causing the fastener 36 to disengage the rod 34, thereby permitting the fastener 36 to be removed from the hole 30.

The fasteners 36 are used to secure the PV panels 14 to the rails 12. Typically, PV panels 14 are formed with holes 40 extending there through to receive the fasteners 36. With reference to FIG. 3, a resilient mounting pad 42 may be placed on the top surface of the rail 12 so that it is disposed between the bottom of the PV panel 14 and the rail 12. The resilient pad 42 may have an opening therein which aligns with the rail mounting holes 30 and allows the fastener 36 to extend there through. The pad 42 may be formed in different configurations, for example, the pad 42 may be in the form of a round washer-like device or an elongate strip of material.

PV panels 14 are installed by first securing a pair of spaced rails 12 to the support structure 13. The PV panel 14 is then placed over the rails 12 and the PV panel holes 40 are aligned with the rail mounting holes 30. A quick access fastener 36 may then be placed through the aligned holes 40, 30 in the panel 14 and rails 12. Downward pressure on the head of the fastener 36a compresses the pad 42 and the fastener 36 is turned to secure it to the rod 34 in the rail 12. Turning of the fastener 36 to the secured position tends to pull it toward the rail 12, further compressing the pad 42. When the panel 14 is secured via the fastener 36, the resilient pad 42 is compressed as the fastener 36 is drawn toward the rail 12. The tension provided by the compressed pad 42 helps to maintain the fastener 36 in the secured position. In order to remove the fastener 36, the head 36a of the fastener 36 is pressed down to compress the pad 42 and then turn the fastener 36 toward the open or unsecured position. The fastener 36 may be removed and the PV panel 14 then lifted off the mounting rail 12.

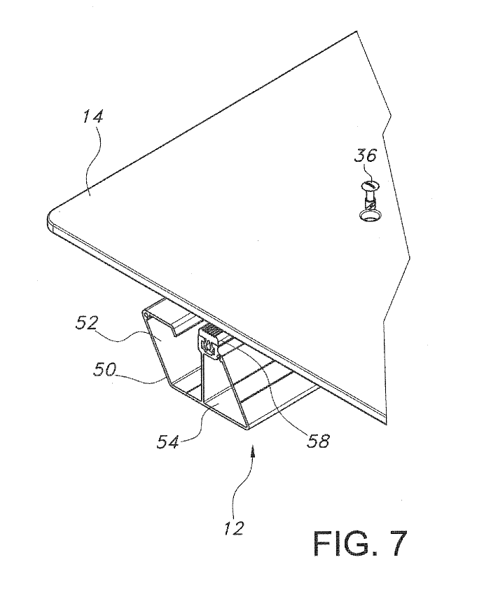

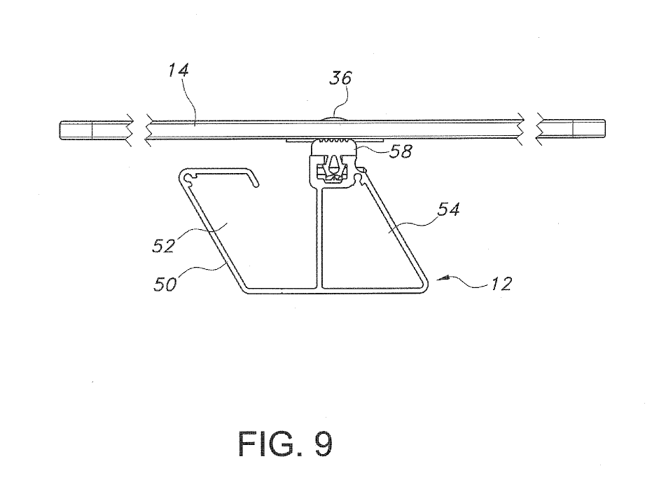

The rail 12 may have different configurations to conform to the design and the mounting hole locations of the PV panel. With reference to FIGS. 7-9, in an alternative embodiment the rail 50 includes an open channel 52 and a closed channel 54. The top surface includes a groove 56 extending along the top length thereof, and a resilient mounting pad 58 is inserted into the groove along its length. The mounting pad 58 may be formed with a depending bottom section 60 that is inserted within the groove 56 and retains the pad 58 in the groove 56. The pad 58 may also have a top flat surface 62 that sits on top of the groove 56 and receives and supports the bottom of the PV panel 14. The resilient pad 58 may extend along the entire length of the rail 12 or alternatively, there may be multiple pads 58 each extending only a certain distance on either side of the mounting hole. When the panel 14 is secured by the fastener 36, the resilient pad 58 is compressed which helps to retain the fastener 36 in the secured position as described above with regard to the embodiment shown in FIGS. 3-4.

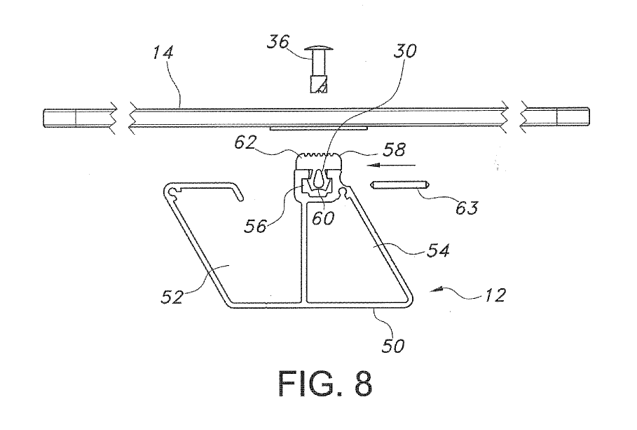

With reference to FIG. 8, as an alternative to using a rod that extends along the length of the rail, a pin 63 may be inserted in the rail 50 at each mounting hole 30. The pins 63 may be inserted generally perpendicular to the length of the rail 12 and fixedly secured to the rail 12. The pins 63 act as an attachment point for a quick access fastener 36

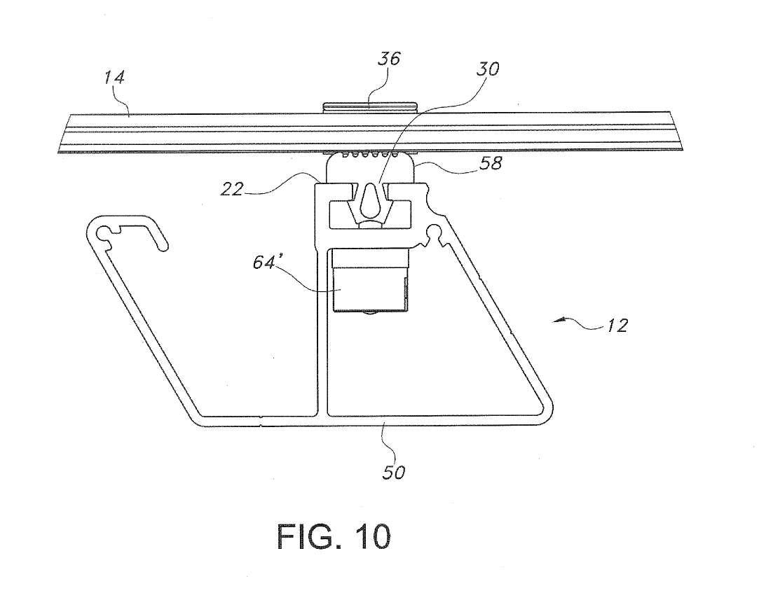

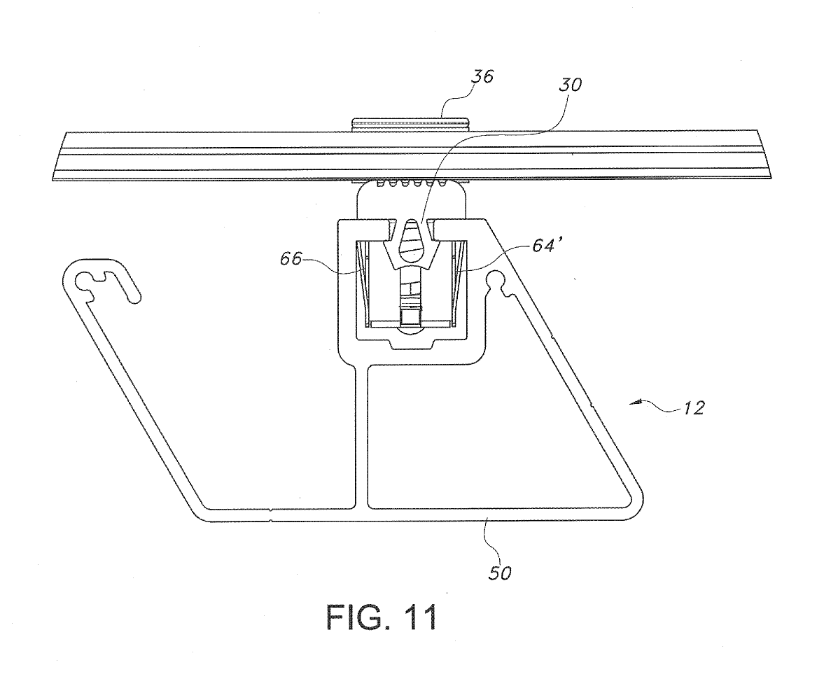

With reference to FIGS. 10 and 11, the quick access fasteners 36 may be secured to the rail 12 by including a retaining device in each mounting hole. In this embodiment, each mounting hole 30 may include a receptacle 64 disposed in the rail 12 for each mounting hole 30. The receptacle 64 may be of a type known in the art for receiving and securing such quick access fasteners 36. For example, as shown in FIG. 10, the fastener 36 may be of a round type 64 which is pressed in through an opening formed in the top plate 22. Alternatively, as shown in FIG. 11, the receptacle 64′ may be of a type having clips 66 which are inserted through a square opening formed in the top of the rail to receive the receptacle 64′. The receptacle 64′ is held in place by the clips 66 formed thereon.

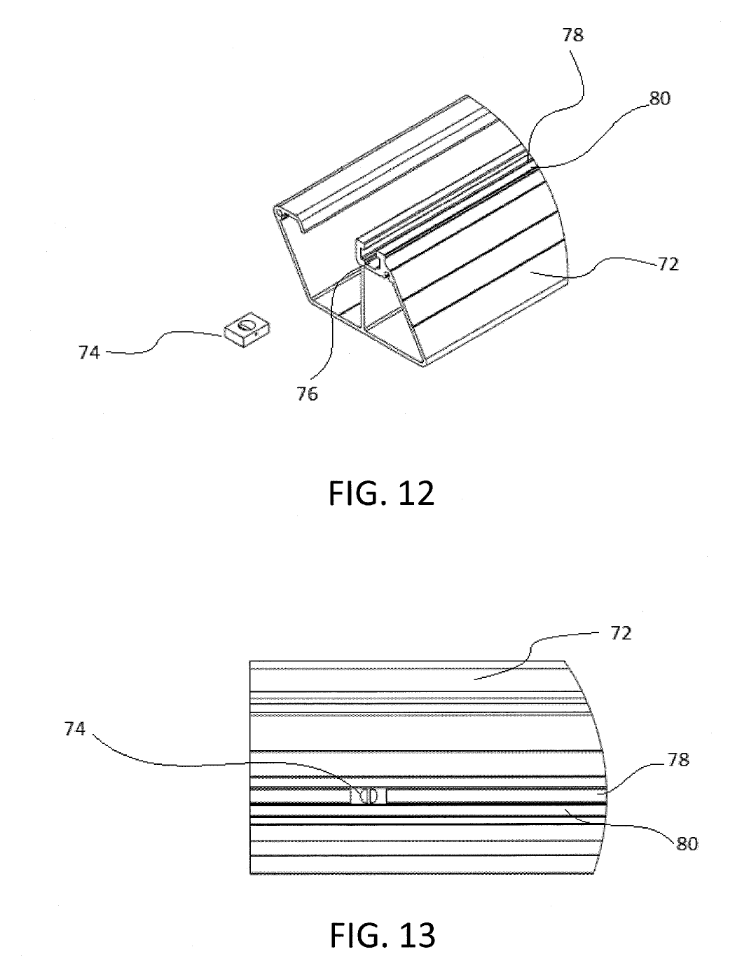

FIGS. 11 and 12 show an embodiment of the present invention in which the rail 72 has a track 78 in the top surface 80 that extends along the length of the rail 72. FIG. 12 illustrates how a nut 74 is inserted in the track 78 at a first end 76 and is captured by the bottom and two sides of the track and the top wall 80. The captured nut 74 slides along the track 78 until it reaches a location that corresponds to the mounting holes of a PV panel (see FIG. 13). A fastener can then be inserted into the hole in the PV panel and engage the captured not 74 to secure the PV panel (not shown) to the rail 72.

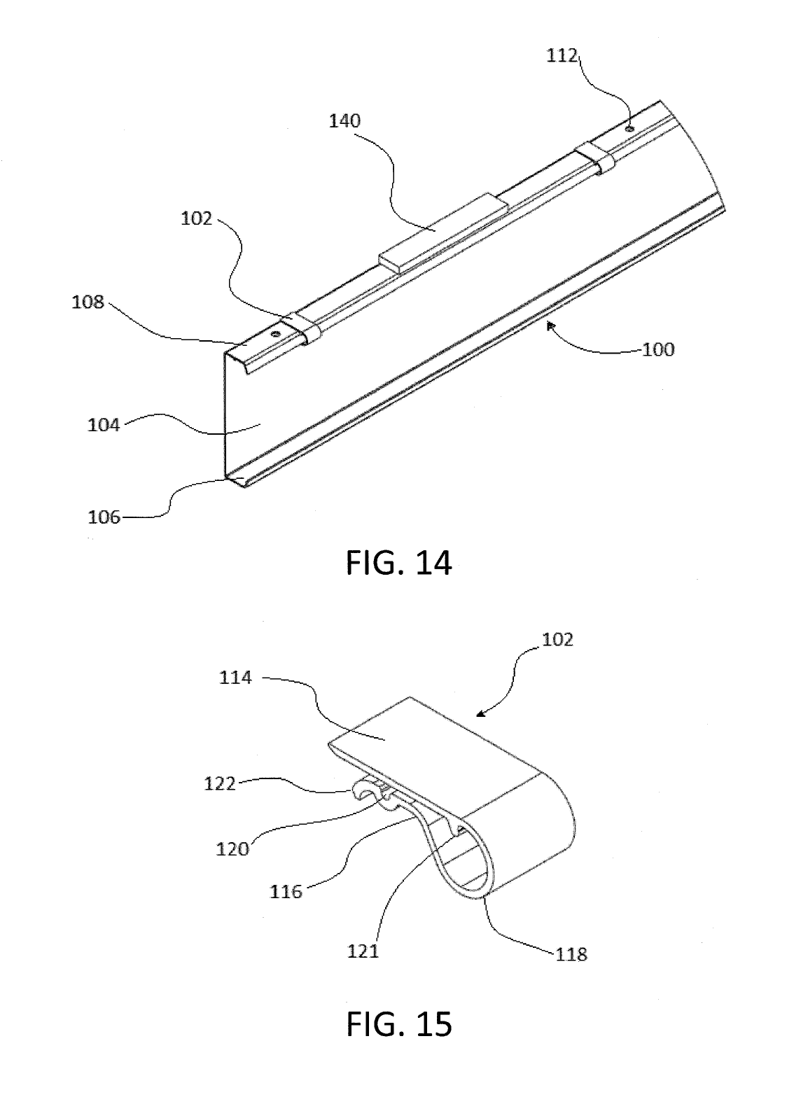

With reference to FIGS. 14-16, an alternative embodiment is shown. The rod 34 may be held in place on a rail 100 by clips 102. Rail 100 may have a generally C-shaped configuration and include a central wall 104 extending along its length bounded by opposed channels 106. Each channel includes a channel wall 108 ending in a lip 110. The wall 104 includes a plurality of mounting openings 112 for receiving a ¼ turn fastener 36. As in the previously describes embodiment, the fastener 36 cooperates with the rod 34 to secure a photovoltaic panel 14 to the rail 100.

The clip 102 may include a top 114 and bottom 116 opposed projections connected at one end by a loop 118. The clip 102 may be formed of a resilient material such as steel, and the top and bottom projections are biased toward each other. The bottom projection 116 may include a notch 120 formed therein to receive the rod 34. The clip 102 is inserted on the rail 100 by placing the lip between the top and bottom clip portion. The clip 102 is then pushed further onto the rail 100 toward the central wall 104. A stop 121 depends downwardly from the top portion adjacent the loop 118. The stop 121 engages the rail 100 when the clip 102 is fully inserted on the rail. The clip bottom portion 116 bay have a leading edge 122 which is curved away from the top portion 114. This facilitates placement of the clip 102 on the rail 100. A plurality of clips 102 may be placed along the length of the rail 100 to secure the rod 34 thereto.

When the clips 102 are in place, the rod 34 may be slid into the notches 120. This may be done by aligning the rod 34 with the length of the rail 100 and sliding the rod 34 into the notches 120. Alternatively, the rod 34 may first be placed inside the rail 100 and the clips 102 placed on the rail 100 and over the rod 34.

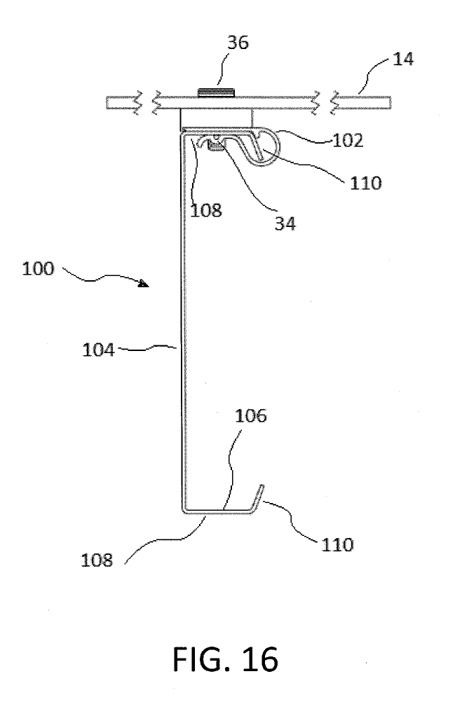

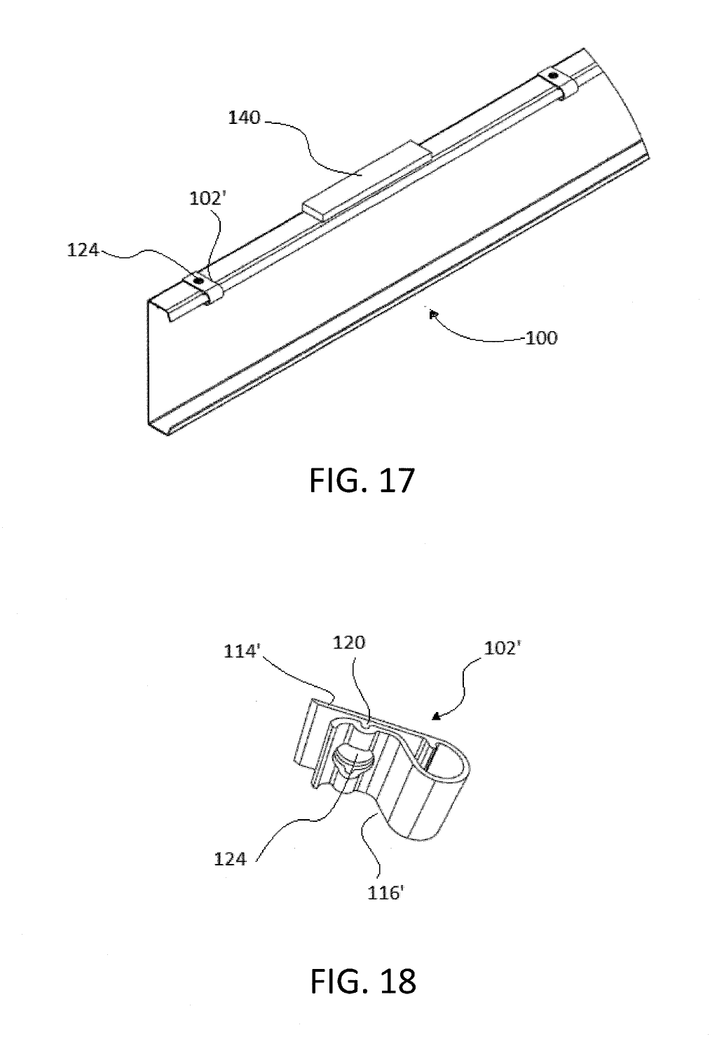

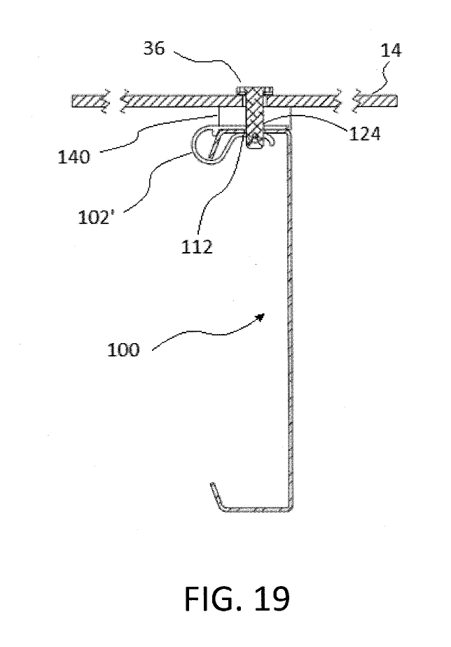

In one embodiment shown in FIGS. 14 and 16, the clips 102 may be placed on the rail 100 offset from the mounting openings 112. The clip top portion 114 may be devoid of any holes. In an alternative embodiment shown in FIGS. 17-19, the clip 102′, top portion 114′ and bottom portion 116′ may each include a through hole 124 for receiving the fastener 36. The clip 102′ may, therefore, be aligned with the mounting opening 112 such that a fastener 36 may pass though the clip 102′ and the rail 100.

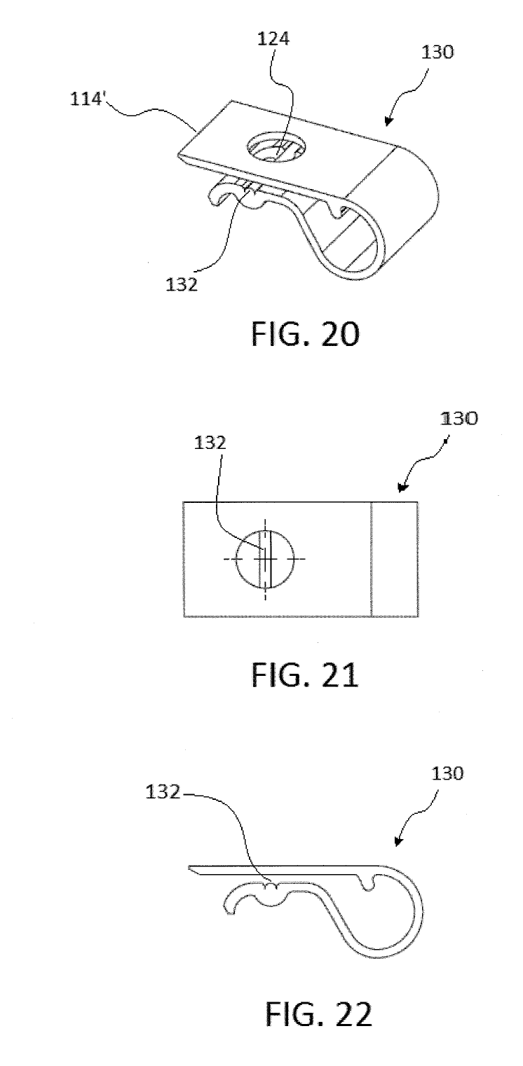

In a further alternative embodiment shown in FIGS. 20-22, the clip 130 may have a fastener pin 132 formed therewith. In this embodiment, a separate rod is not used. The clip 130 is formed similar to the clip 102′ described above with respect to FIGS. 17 to 19, having a hole 124 in top portion 114′ and bottom portion 116′. However, in the notch is fixedly disposed a pin 132 extending along the hole of the bottom portion 116. The pin 132 may be integrally formed with the clip. The clips 130 are secured to the rail 100 such that the clip hole 124 aligns with the rail mounting opening 112. The fastener 36 can then pass through both openings and engage the pin 132 to secure the PV panel to the rail 100.

With reference to FIGS. 14 and 16, in order to provide support for the panel on the rail 100, resilient pads 140 may be placed on the rail 100. Alternatively, the pads 140 may be placed on the top portion of the clips. When the panel 14 is secured via the fastener 36, the resilient pad 140 is compressed as the fastener 36 is drawn toward the rail 100. The tension provided by the compressed pad 140 helps to maintain the fastener 36 in the secured position.

Thus, while there have been described the preferred embodiments of the present invention, those skilled in the art will realize that other embodiments can be made without departing from the spirit of the invention, and it is intended to include all such further modifications and changes as come within the true scope of the claims set forth herein.

We claim:

1. A photovoltaic panel mounting system comprising:
a pair of spaced mounting rails each comprising a first end, a second end and a plurality of mounting holes;
one or more fastener retaining devices aligned with the plurality of mounting holes in each of the rails; and
a plurality of quick access fasteners, each quick access fastener removably secured to one of the rails through one of the plurality of mounting holes, each quick access fastener being securable and removable to one of the one or more fastener retaining devices with less than one revolution of the quick access fastener.

2. The photovoltaic panel mounting system according to claim 1, wherein the one or more fastener retaining devices comprises a rod extending along the length of the rail.

3. The photovoltaic panel mounting system according to claim 1, wherein the one or more fastener retaining devices comprises a pin in the rail located at each of the plurality of mounting holes.

4. The photovoltaic panel mounting system according to claim 1, wherein each of the pair of spaced mounting rails is elongated and further comprises a base, first and second side walls extending upwardly therefrom and one or more top plates, and wherein the first and second top plates extend inwardly from the side walls and parallel to the base to define an interior.

5. The photovoltaic panel mounting system according to claim 4, wherein the plurality of mounting holes are formed in the one or more top plates.

6. The photovoltaic panel mounting system according to claim 5, wherein each of the pair of spaced mounting rails further comprises a passage having a first end and a second end corresponding to the first and second ends of the rails, wherein the passage is located in the interior and is in communication with the plurality of mounting holes, and wherein the one or more fastener retaining devices are positioned in the passage.

7. The photovoltaic panel mounting system according to claim 1, wherein the plurality of quick access fasteners are quarter turn fasteners.

8. The photovoltaic panel mounting system according to claim 7, wherein each quarter turn fasteners has a head with a shaft extending therefrom to a distal end.

9. The photovoltaic panel mounting system according to claim 8, wherein the one or more fastener retaining devices is a rod located in a passage in each rail, wherein the rod and the passage extend the length of the rail, wherein each quarter turn fastener has an engaged position and a disengaged position, and wherein, when in the engaged position, the distal end of the fastener engages the rod and the fastener is secured to the mounting rail, and, when in the disengaged position, the fastener does not engage the rod and the fastener is not secured to the mounting rail.

10. The photovoltaic panel mounting system according to claim 2, wherein the rod is secured to the rail by a plurality of clips.

11. The photovoltaic panel mounting system according to claim 10, wherein the clips include opposed portions resiliently engaged with the rail, and include a notch for securing the rod.

12. The photovoltaic panel mounting system according to claim 11, wherein each of the clips include a hole there through for receiving one of the plurality of fasteners.

13. A photovoltaic panel mounting system comprising:
a pair of spaced mounting rails each having a first end and a second end and comprising a bottom wall, a top plate and one or more side walls therebetween, wherein the bottom wall, top plate and one or more side walls define an interior and an exterior, wherein the top plate has a plurality of mounting holes;
one or more fastener retaining devices located in the interior and aligned with the plurality of mounting holes in each of the rails; and
a plurality of quick access fasteners, each quick access fastener removably secured to one of the rails through one of the plurality of mounting holes, each quick access fastener being securable and removable to one of the one or more fastener retaining devices with less than one revolution of the quick access fastener.

14. The photovoltaic panel mounting system according to claim 13, wherein each mounting rail has a passage extending between the first and second ends, wherein the passage is in communication with the exterior through the plurality of mounting holes.

15. The photovoltaic panel mounting system according to claim 14, wherein the passage is formed by two curved walls extending from the top plate into the interior.

16. The photovoltaic panel mounting system according to claim 13, wherein the one or more fastener retaining devices is a rod located in the passage and extending between the first and second ends of the rail.

17. The photovoltaic panel mounting system according to claim 13, wherein the plurality of quick access fasteners are quarter turn fasteners.

18. The photovoltaic panel mounting system according to claim 17, wherein each quarter turn fastener has a head with a shaft extending therefrom to a distal end.

19. The photovoltaic panel mounting system according to claim 17, wherein the one or more fastener retaining devices is a rod located in the passage and extending between the first and second ends of the rail, wherein each quarter turn fastener has an engaged position and a disengaged position, and wherein, when in the engaged position, the fastener engages the rod and the fastener is secured to the mounting rail, and, when in the disengaged position, the fastener does not engage the rod and the fastener is not secured to the mounting rail.

20. A photovoltaic panel mounting system comprising:
a pair of spaced mounting rails each having a first end and a second end and comprising a bottom wall, a top plate and one or more side walls therebetween, wherein the bottom wall, top plate and one or more side walls define an interior and an exterior, wherein the top plate has a plurality of mounting holes;
a passage extending between the first and second ends of each mounting rail, wherein the passage is in communication with the exterior through the plurality of mounting holes.
a fastener retaining device comprising a rod located in the passage of each rail and extending between the first and second ends of the rail, wherein the rod is aligned with the plurality of mounting holes; and
a plurality of quick access fasteners, each quick access fastener having a distal end and removably secured to one of the rails through one of the plurality of mounting holes, each quick access fastener being securable and removable to the rail with less than one revolution of the quick access fastener.

21. The photovoltaic panel mounting system according to claim 20, wherein each quick access fastener has an engaged position and a disengaged position, and wherein, when in the engaged position, a notch near the distal end of the quick access fastener engages the rod and the quick access fastener is secured to the mounting rail, and, when in the disengaged position, the notch near the distal end of the quick access fastener does not engage the rod and the quick access fastener is not secured to the mounting rail.

22. The photovoltaic panel mounting system according to claim 20, wherein the plurality of quick access fasteners are quarter turn fasteners having a head with a shaft extending therefrom to the distal end.

23. The photovoltaic panel mounting system according to claim 20, wherein the passage is formed by two curved walls extending from the top plate into the interior.

24. The photovoltaic panel mounting system according to claim 20, including a plurality of clips resiliently engaged with the rail, the clips securing the rod to the rail.

25. The photovoltaic panel mounting system according to claim 24, wherein each of the clips include a hole there through for receiving one of the plurality of fasteners.
